(19) United States
(12) Patent Application Publication
(10) Pub. No.: US 2008/0301770 A1
(43) Pub. Date: Dec. 4, 2008

(54) Identity based virtual machine selector

(76) Inventor: Nathan G. Kinder, Castro Valley, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/809,273

(22) Filed: May 31, 2007

(51) Int. Cl. H04L 9/32; G06F 15/16

(52) U.S. Cl. 726/2; 709/223

(57) ABSTRACT

A method and apparatus for allowing an authenticated user to select and access a virtual machine (VM) over the network. In one embodiment, the method includes maintaining a map to associate a user with a list of VMs. The VM runs a guest operating system for providing a computing environment for the user when loaded onto a physical machine. The method further includes receiving a request identifying the user, and sending a reply indicating locations of the VMs to the physical machine for selection by the user.

### TECHNICAL FIELD

Embodiments of the present invention relate to virtual machines management, and more specifically, to managing the access to virtual machines based on the identity of a requester.

### BACKGROUND

An enterprise often spends a large sum on computer equipment for its employees. Each computer is typically installed with a sophisticated operation system and application software, and is typically dedicated to the use of a single person. User files and user settings are usually stored on the user's local computer and are not easily accessible from another location.

Moreover, it is generally a problem to remotely access application software that is designed to run under only a particular operating system. For example, a user may wish to remotely access, from a computer installed with an operating system X, application software that runs under only an operating system Y. This software incompatibility often complicates the remote accessibility of a user's computing environment via a network.

Data security is another important issue when designing a networked environment that allows remote access to personal data and settings. Thus, there is a need to develop a secure and cost-effective technique that allows a user to access his/her computing environment from any physical machine.

### BRIEF DESCRIPTION OF THE DRAWINGS

The present invention is illustrated by way of example, and not by way of limitation, in the figures of the accompanying drawings and in which:

FIG. 1 illustrates a network architecture in which embodiments of the present invention may be implemented.

FIG. 2 is a flow diagram of one embodiment of a method for providing virtual machine (VM) access to an authenticated user.

FIG. 3 is a flow diagram of one embodiment of a method for providing an interface for a user to access a server and to select VMs.

FIG. 4 illustrates a block diagram of an exemplary computer system implementing some embodiments of the present invention.

### DETAILED DESCRIPTION

Described herein is a method and apparatus for providing an identity-based virtual machine (VM) selector. In one embodiment, an identity server maintains a VM map to associate a user with a VM. The VM runs a guest operating system (OS) for the user when loaded onto a user's physical machine. Upon receiving an authentication request from the physical machine to authenticate the user, the identity server performs the authentication, and sends a reply indicating a location of the VM to the physical machine if the authentication is successful. In another embodiment, the identity server may return a list of accessible VMs upon a successful authentication. The user may then select one or more the VMs from the list to run on the physical machine.

Embodiments of the invention allow a user to gain access to his computing environment, including, user data, user settings, and application software, etc., from any physical machine installed with minimal software. The user's computing environment is provided by the VMs loaded on to the physical machine. The advantage of this approach is that each physical machine can be setup exactly the same with just a shim OS. The term “shim OS” herein refers to an OS that has a minimal set of packages needed to communicate with a server. In some embodiments, the shim OS can be read-only so end-users are unable to mess up the system. Another advantage of the approach is that the task of managing software changes is simplified, as the changes can be applied to the VMs located on servers instead of on each individual client machines.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing,” “providing,” “maintaining,” “controlling,” “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description below. In addition, the present invention is not described with reference to any particular programming language. It will be appreciated that a variety of programming languages may be used to implement the teachings of the invention as described herein.

A machine-accessible storage medium includes any mechanism for storing or transmitting information in a form readable by a machine (e.g., a computer). For example, a machine-accessible storage medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

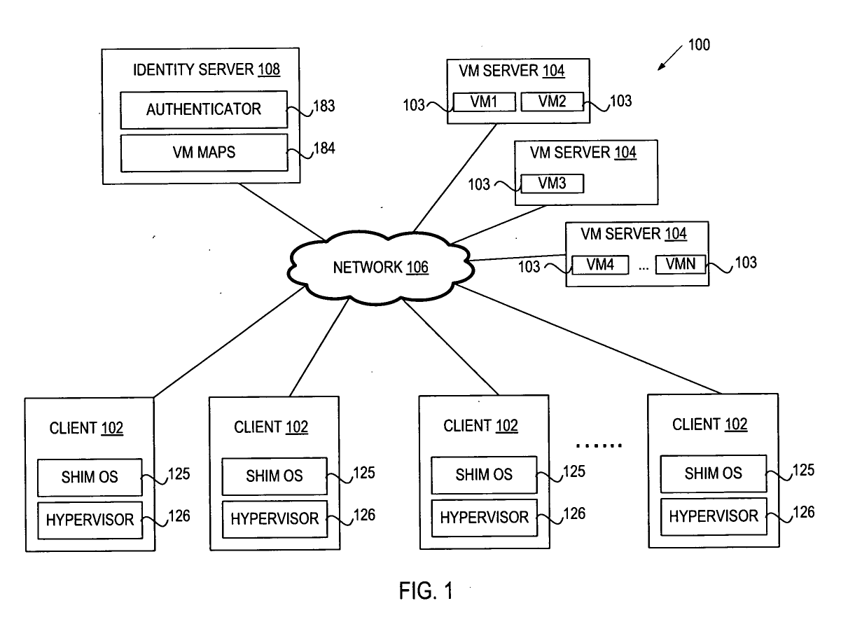

FIG. 1 illustrates an exemplary network architecture 100 in which embodiments of the present invention may operate. The network architecture 100 may include client devices (clients) 102, an identity server 108, virtual machine (VM) servers 104 and a network 106. Each client 102 represents a physical machine. The clients 102 may be, for example, personal computers (PCs), mobile phones, palm-sized computing devices, personal digital assistants (PDAs), and the like.

In one embodiment, each client 102 is installed with a shim OS 125 and a hypervisor (or a virtual machine monitor (VMM)) 126. The shim OS 125 supports a user interface and a network interface to communicate with the identity server 108. The shim OS 125 on each client 102 may be identical and stores no personal settings. The network interface also allows users to remotely access the VM servers 104 and to download the VMs 103 that the users are authorized to run. Each VM runs a guest operating system for the user when it is downloaded to the user's client 102. The guest operating system includes the user's computing environment, including the user's data, settings, application software, etc. Thus, it is not necessary for the shim OS 125 to maintain the user's computing environment locally.

In one scenario, the client 102 may run multiple VMs concurrently, each executing a different operating system. The execution of these operating systems may be managed by the hypervisor 126. The hypervisor 126 may run directly on the physical platform of the client 102 to provide an interface between the hardware and the operating systems that it manages.

The clients 102 are coupled to the identity server 108 via the network 106, which may be a public network (e.g., Internet) or a private network (e.g., Ethernet or a local area Network (LAN)). The identity server 108 may contain a server front-end responsible for network communications, logic for server functions (such as an authenticator 183 for user authentication), a basic directory tree containing server-related data, and memory for storing a VM map 183 that associates a user with a list of one or more VMs 103 to which the user is authorized to access.

The network architecture 100 may also include one or more VM servers 104 hosting various VMs 103, which are remotely accessible to the clients 102 via the network 106 and downloadable to the clients 102 upon a successful authentication of the user. The clients 102 may communicate with the VM servers 104 directly. However, the clients 102 do not know in advance the locations of the VMs 103 to which they may be allowed to access. The network addresses of the VM servers 104 hosting theses VMs 103 will be provided by the identity server 108 after the user is successfully authenticated.

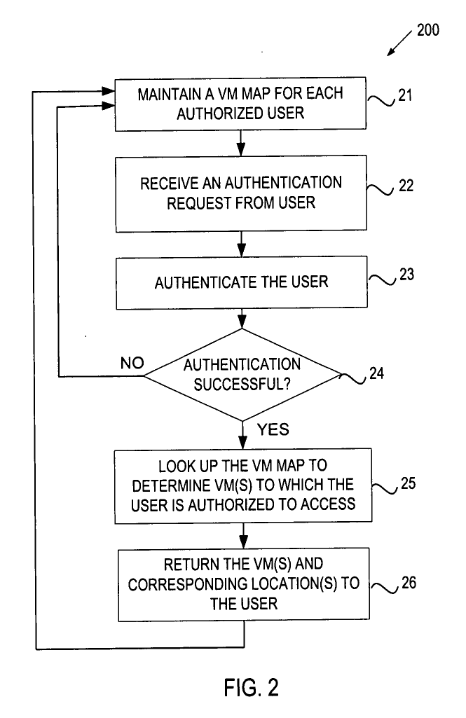

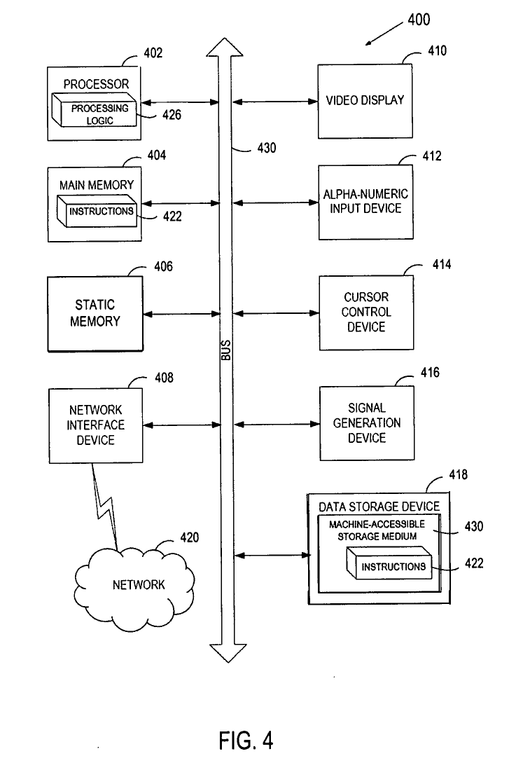

FIG. 2 illustrates a flow diagram of one embodiment of a process 200 for providing VM access to an authenticated user. The process 200 may be performed by processing logic 426 of FIG. 4 that may comprise hardware (e.g., circuitry, dedicated logic, programmable logic, microcode, etc.), software (such as instructions run on a processing device), or a combination thereof. In one embodiment, the process 200 is performed by the identity server 108 of FIG. 1.

Referring to FIG. 2, at block 21, the process 200 begins with the processing logic 426 maintaining the VM map 184 in a memory 406 or a storage device 418 of FIG. 4. In one embodiment, the VM map 184 includes an entry for each authenticated user. Each entry includes an identifier of the user and a list containing one or more VMs 103 to which the user is authorized to access. For each VM 103 in the list, the VM map 184 includes a pointer indicating the location of the VM 103. The location of the VM 103 may be represented by a combination of the network address of the VM server 104 hosting the VM 103 and an identifier that uniquely identifies the VM 103 within the hosting VM server 104.

In one embodiment, the VM map 184 may be constructed based on an access policy defined by a system administrator. For example, the access policy may be a role-based policy that permits user access to a subset of the VMs 103 based on a role of the user with an organization, e.g., the rank, employment status, group association etc., of the users. In one embodiment, the role of a user may be determined by consulting a Lightweight Directory Access Protocol (LDAP) server, which returns a user's role in response to a query identifying the user. Further, in some embodiments, the access policy may be based on a machine attribute of the user's physical machine. The machine attribute may include, for example, public accessibility, security levels, geographical locations, machine types, etc. For example, if the user is on a physical machine located in a public location (e.g., a terminal in the public kiosk), the user may be denied access to some of the VMs 103 in the VM map 184 that contains sensitive information, but may be instead allowed to access some demo version of the application software. As another example, if the user is on a laptop computer, the user may be denied access to most or all VMs after a successful authentication.

Additionally, the VM map 184 may record the check-out status of each VM 103. For example, if a VM 103 can be checked out by only a limited number of users at a time, the check-out status of the VM 103 will be marked as “unavailable” once the check-out limit has been reached.

At block 22, processing logic 426 receives an authentication request from a client, indicating that a user wishes to log onto the identity server 108 to access his data and settings. The authentication request may be accompanied by a password and a user ID. The authentication request may also identify the physical machine that originates the request, i.e., the physical machine where the user is on. The physical machine may be identified by including a certificate of the physical machine in the request. The certificate may be, for example, issued to the physical machine in a registration process when the physical machine is registered with the identity server 108. At block 23, the identity server 108 authenticates the user, e.g., by verifying the user's ID and password. In some embodiments, the identity server 108 may also verify whether the physical machine is authorized to communicate with the server 108 by checking its certificate. At block 24, the success of the authentication is determined. If the authentication is not successful, the process 200 returns to block 21. If the authentication is successful, at block 25, the identity server 108 looks up the VM map 184 to determine a list of VMs that the user is authorized to run. The identity server 108 may use the user's identity, the user's role, attributes of the user's physical machine, a combination of some or all of the above, etc., to perform the lookup. At block 26, the identity server 108 returns the list of the VMs and their locations to the user. The process 200 then returns to block 21, maintaining the VM map 184 and waiting for the next authentication request to arrive.

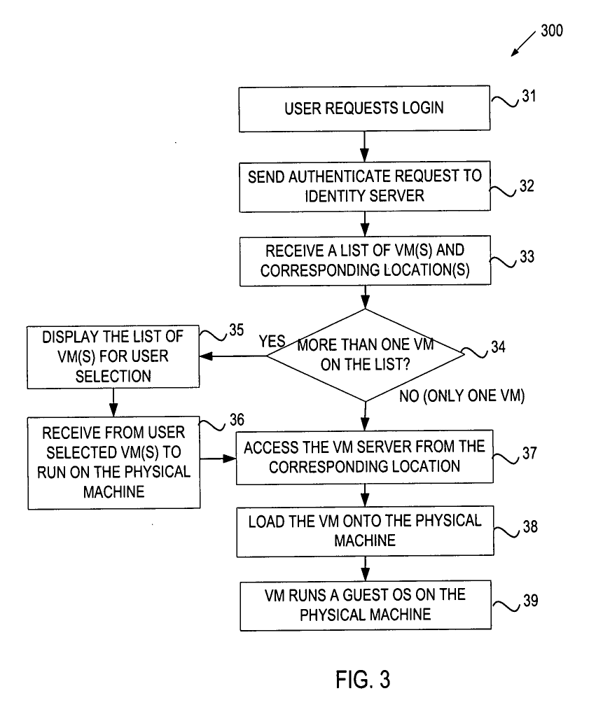

FIG. 3 illustrates a flow diagram of one embodiment of a process 300 for providing an interface for a user to access a server (e.g., the identity server 108) and to select VMs 103. The process 300 may be performed by processing logic 426 of FIG. 4 that may comprise hardware (e.g., circuitry, dedicated logic, programmable logic, microcode, etc.), software (such as instructions run on a processing device), or a combination thereof. In one embodiment, the process 300 is performed by the client 102 of FIG. 1.

Referring to FIG. 3, at block 31, the process 300 begins with the processing logic 426 receiving a login request from the user. In response to the request, at block 32, the processing logic 426 sends an authentication request to the identity server 108. As mentioned above in FIG. 2, if the authentication is successful, at block 33, a list of VMs 103 and corresponding locations are returned. If the list contains more than one VM 103 (block 34), the list is displayed on the video display 410 of FIG. 4 for the user (block 35). At block 36, the user may be prompted to select one or more of the VMs 103 (referred to as the selected VM) on the list to run on the user's physical machine. The process 300 then proceeds to block 37.

If, at block 34, the list includes only one VM 103, the operations of blocks 35 and 36 can be omitted and the process 300 directly proceeds to block 37. This VM 103 will also be referred to as the selected VM in blocks 37-39, as the discussion for both decision branches of block 34 becomes identical from this point. At block 37, the VM server 104 hosting the selected VM is accessed, using the location information returned from the identity server 108. The location of the selected VM on the hosting VM sever 104 is also identified. At block 38, the selected VM is loaded onto the user's physical machine from the VM server 104 via the network 106. At block 39, the selected VM 103 runs a guest OS on the user's physical machine to provide the user's computing environment on the physical machine.

FIG. 4 illustrates a diagrammatic representation of a machine in the exemplary form of a computer system 400 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 400 includes a processing device 402, a main memory 404 (e.g., read-only memory (ROM), flash memory, dynamic random access memory (DRAM) such as synchronous DRAM (SDRAM) or Rambus DRAM (RDRAM), etc.), a static memory 406 (e.g., flash memory, static random access memory (SRAM), etc.), and a data storage device 418, which communicate with each other via a bus 430.

Processing device 402 represents one or more general-purpose processing devices such as a microprocessor, central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 402 may also be one or more special-purpose processing devices such as an application specific integrated circuit (ASIC), a field programmable gate array (FPGA), a digital signal processor (DSP), network processor, or the like. The processing device 402 is configured to execute the processing logic 426 for performing the operations and steps discussed herein.

The computer system 400 may further include a network interface device 408. The computer system 400 also may include a video display unit 410 (e.g., a liquid crystal display (LCD) or a cathode ray tube (CRT)), an alphanumeric input device 412 (e.g., a keyboard), a cursor control device 414 (e.g., a mouse), and a signal generation device 416 (e.g., a speaker).

The data storage device 418 may include a machine-accessible storage medium 430 on which is stored one or more sets of instructions (e.g., software 422) embodying any one or more of the methodologies or functions described herein. The software 422 may also reside, completely or at least partially, within the main memory 404 and/or within the processing device 402 during execution thereof by the computer system 400, the main memory 404 and the processing device 402 also constituting machine-accessible storage media. The software 422 may further be transmitted or received over a network 420 via the network interface device 408.

The machine-accessible storage medium 430 may also be used to store the code implementing the VM map 184 of the identity server 108 or the shim OS 125 of the client 102. The VM map 184 or the shim OS 125 may also be stored in other sections of computer system 400, such as static memory 406.

While the machine-accessible storage medium 430 is shown in an exemplary embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instructions for execution by the machine and that cause the machine to perform any one or more of the methodologies of the present invention. The term “machine-accessible storage medium” shall accordingly be taken to include, but not be limited to, solid-state memories, optical and magnetic media, and carrier wave signals.

Thus, a method and apparatus for providing an identity-based virtual machine (VM) selector have been described. It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A computer-implemented method comprising:
maintaining a map to associate a user with virtual machines (VMs), each VM running a guest operating system for providing a computing environment for the user when loaded onto a physical machine; and
in response to a request identifying the user, sending a reply indicating locations of the VMs to the physical machine for selection by the user.

2. The method of claim 1 further comprising:
receiving a user selection, at the physical machine, of one or more of the VMs to run on the physical machine.

3. The method of claim 1 further comprising:
authenticating the user after receiving the request; and
in response to a successful authentication of the user, returning the locations of the VMs to the physical machine.

4. The method of claim 1 wherein the physical machine is installed with a shim host operating system.

5. The method of claim 1 further comprising:
providing a list of VMs accessible by the user based on an attribute of the physical machine and an identity of the user.

6. The method of claim 1 wherein the guest operating system includes application software that the user is allowed to run.

7. The method of claim 1 wherein the guest operating system includes data and settings of the user.

8. The method of claim 1 further comprising:
constructing the VM map based on a role-based policy pertaining to user identity.

9. The method of claim 1 further comprising:
providing a list of VMs accessible by the user based on a security level of the physical machine.

10. The method of claim 1 further comprising:
returning the locations of the VMs if both the user and the physical machine originating the request are authorized to access the VMs.

11. A system comprising:
memory to maintain a map that associates a user with virtual machines (VMs), the VMs to run a guest operating system for providing a computing environment for the user when loaded onto physical machines; and
an interface, coupled to the memory, to receive an authentication request from one of the physical machines, and to return locations of the VMs to the one of the physical machines in response to the request.

12. The system of claim 11 wherein the map is constructed to provide a list of VMs accessible by the user based on an attribute of the physical machines and an identity of the user.

13. The system of claim 11 wherein the interface is to return the locations of the VMs if both the user and the physical machine originating the request are authorized to access the VM.

14. The system of claim 11 wherein each of the physical machines includes a user interface to receive a selection of the VMs from the user and a network interface to send the authentication request.

15. The system of claim 11 wherein the system further comprises:
an authenticator to process the authenticate request and to authenticate the user for accessing the VMs.

16. The system of claim 11 wherein each of the physical machines includes a hypervisor to manage multiple operating systems run by the VMs.

17. An article of manufacture, comprising:
a machine-accessible storage medium including data that, when accessed by a machine, cause the machine to perform a method comprising:
maintaining a map to associate a user with virtual machines (VMs), each VM running a guest operating system for providing a computing environment for the user when loaded onto a physical machine installed with a shim host operating system; and
in response to a request identifying the user, sending a reply indicating locations of the VMs to the physical machine for selection by the user.

18. The article of manufacture of claim 17 wherein the method further comprises:
constructing the map to provide a list of VMs accessible by the user based on an attribute of the physical machine and an identity of the user.

19. The article of manufacture of claim 17 wherein sending a reply further comprises:
sending the reply if the user and the physical machine are both authorized to access the VMs.

20. The article of manufacture of claim 17 wherein the method further comprises:
controlling access to the VMs according to a check-out status of the VMs.

21. A computer-implemented method comprising:
receiving a list of virtual machines (VMs) from an identity server in response to a successful authentication of a user, each VM running a guest operating system when loaded on to a physical machine; and
presenting the list of VMs to the user for use selection.

22. The method of claim 21 further comprising:
receiving one or more selected VMs from the user; and
loading the one or more selected VMs via a network.

23. The method of claim 21 further comprising:
running a shim operating system on the physical machine to handle communication with the identity server and with the user; and
running one or more of the guest operating systems on the physical machine to provide a computing environment for the user.

24. An article of manufacture, comprising:
a machine-accessible storage medium including data that, when accessed by a machine, cause the machine to perform a method comprising:
receiving a list of virtual machines (VMs) from an identity server in response to a successful authentication of a user, each VM running a guest operating system for providing a computing environment for the user when loaded on to a physical machine installed with a shim host operating system; and
presenting the list of VMs to the user for use selection.

25. The article of manufacture of claim 24 wherein the method further comprises:
receiving one or more selected VMs from the user; and
loading the one or more selected VMs via a network.
